(19) United States
(12) Patent Application Publication
(10) Pub. No.: US 2015/0348082 A1
(43) Pub. Date: Dec. 3, 2015

(54) MESSAGING SYSTEM FOR DELIVERING MESSAGES IN PORTIONS

(71) Applicant: GiveSome GetSome Group Ltd, Helsinki (FI)

(72) Inventor: Wintom Zecarias, Helsinki (FI)

(21) Appl. No.: 14/725,446

(22) Filed: May 29, 2015

Related U.S. Application Data
(60) Provisional application No. 62/005,310, filed on May 30, 2014.

(51) Int. Cl. G06Q 30/02; G06Q 50/00; H04L 12/58

(52) U.S. Cl. CPC G06Q 30/0222; G06Q 30/0269; G06Q 30/0261; H04L 51/08; G06Q 50/01

(57) ABSTRACT

A messaging system is provided. The messaging system includes a plurality of client devices, and a server arrangement coupled in communication with the plurality of client devices. The server arrangement is operable to receive, from a first client device, a message to be delivered to a second client device. The server arrangement is then operable to send, to the second client device, a request message requesting a user associated with the second client device to perform a predetermined trigger event. Subsequently, the server arrangement is operable to deliver at least a portion of the message to the second client device, when the user associated with the second client device performs the predetermined trigger event.

This application claims the benefit of U.S. Provisional Application No. 62/005,310, filed 30 May 2014, which is incorporated by reference in its entirety.

### TECHNICAL FIELD

The present disclosure generally relates to message delivery, and more specifically, to messaging systems for delivering messages in portions. Moreover, the present disclosure also relates to methods of delivering messages in portions.

### BACKGROUND

Messaging systems for delivering messages have been in place for decades. Conventionally, message delivery has been facilitated by electronic mail (email), Multimedia Messaging Service (MMS), Short Messaging Service (SMS), and social networking websites, such as Facebook (Facebook is a registered trademark).

Conventional messaging systems facilitate delivery of a message from a sender to one or more receivers. Such delivery of messages is substantially instantaneous. In other words, a message is delivered to its receiver(s) substantially immediately after it has been sent by its sender.

In order to make messaging more convenient, some conventional messaging systems allow a sender to create a message well in advance, and to specify a time for delivery of the message. The message is then delivered to its receiver(s) when the time specified by the sender arrives.

However, no attempt has been made to provide a messaging experience that is interesting for both senders and receivers. Therefore, there exists a need for a messaging system that is capable of providing a messaging experience that is interesting.

### SUMMARY

The present disclosure seeks to provide a messaging system for delivering messages in an interesting and gamified manner.

The present disclosure also seeks to provide a method of delivering messages in an interesting and gamified manner.

In one aspect, embodiments of the present disclosure provide a messaging system for delivering messages. The messaging system includes a plurality of client devices, and a server arrangement coupled in communication with the plurality of client devices.

The server arrangement is operable to receive, from a first client device, a second message to be delivered to a second client device. The server arrangement is then operable to send, to the second client device, a first request message requesting a user associated with the second client device perform a predetermined trigger event. Subsequently, the server arrangement is operable to deliver at least a portion of the message to the second client device, when the user associated with the second client device performs the predetermined trigger event.

Optionally, the at least a portion of the message includes a reward that is redeemable at an enterprise. In this regard, the server arrangement is operable to communicate instructions for redemption of the reward to the enterprise, when the user performs the predetermined trigger event.

Optionally, the predetermined trigger event is considered to be performed when the user reaches a geographical location of the enterprise.

Alternatively or additionally, optionally, the predetermined trigger event is considered to be performed when the second client device sends a trigger code to the server arrangement. For this purpose, the server arrangement is operable to deliver, to the enterprise, a trigger code to be used for the predetermined trigger event. When the user visits the enterprise, a merchant or a representative of the enterprise provides the trigger code to the user who then sends the trigger code from the second client device to the server arrangement.

Moreover, optionally, the server arrangement is operable to deliver a remainder of the message to the second client device after the reward is redeemed by the user.

In at least one embodiment, the enterprise comprises a retail store.

In one or more embodiments, the reward comprises a gift voucher.

In another aspect, embodiments of the present disclosure provide a method of delivering messages. The method includes receiving from a first client device, a second message to be delivered to a second client device, sending to the second client device, a first message requesting performance of a predetermined trigger event, and delivering at least a portion of the second message to the second client device upon performance of the predetermined trigger event.

The method may include delivering a reward with the at least a portion of the second message and, upon performance of the predetermined trigger event, communicating instructions for redemption of the reward to an enterprise providing the reward.

The method may also include performing the predetermined trigger event upon arriving at the enterprise.

The method may further include delivering to the enterprise a trigger code to be used for the predetermined trigger event.

The method may still further include delivering a remainder of the message to the second client device after the reward is redeemed by the user.

In yet another aspect, embodiments of the present disclosure provide a computer program product including a non-transitory machine-readable data storage medium having stored thereon program instructions that, when accessed by a processing device, cause the processing device to perform the aforementioned method.

Embodiments of the present disclosure substantially eliminate or at least partially address the aforementioned problems in the prior art, and enable users to send messages and/or gift vouchers to other users in an interesting and gamified manner.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a messaging system, in accordance with an embodiment of the present disclosure;

FIG. 2 is a schematic illustration of an example data flow within the messaging system, in accordance with an embodiment of the present disclosure;

FIG. 3 is an illustration of a series of views displayed on an example user interface corresponding to a receiving user, in accordance with an embodiment of the present disclosure;

FIGS. 4A-G are illustrations of screenshots of various views displayed on a user interface of a given client device, in accordance with an embodiment of the present disclosure;

FIG. 5 is an illustration of steps of a method of delivering messages, in accordance with an embodiment of the present disclosure; and

FIG. 6 is an illustration of example flow chart of method of delivering messages to a user.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

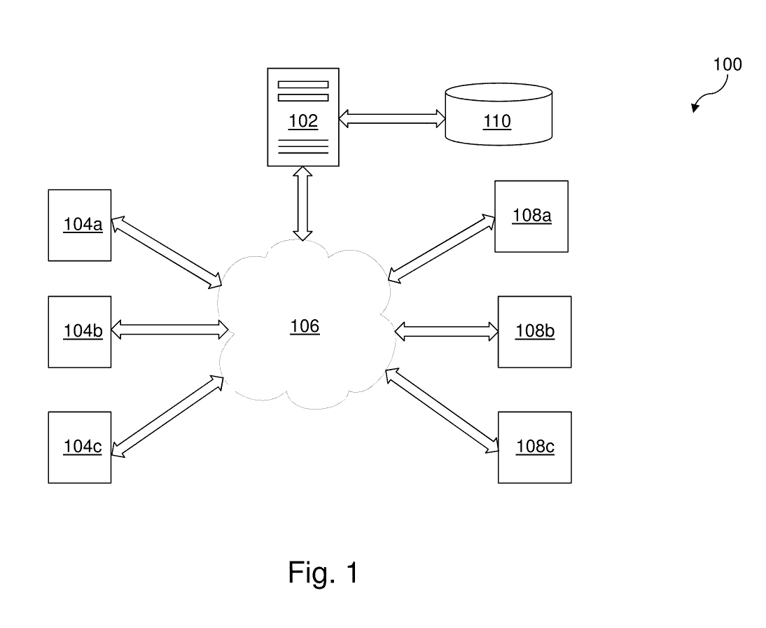

FIG. 1 is a schematic illustration of a messaging system 100, in accordance with an embodiment of the present disclosure. The messaging system 100 includes a server arrangement 102, a plurality of client devices, depicted as a client device 104a, a client device 104b and a client device 104c (hereinafter collectively referred to as client devices 104), and a communication network 106. The messaging system 100 also includes one or more enterprises, depicted in this example as a retail store 108a, a retail store 108b, and a retail store 108c (hereinafter collectively referred to as retail stores 108). While the enterprises are depicted in this example as retail stores, it should be understood an enterprise includes any business suitable for providing rewards to a user. The messaging system 100 also includes one or more databases, depicted as a database 110. The database 110 is optionally associated with the server arrangement 102.

The messaging system 100 may be implemented in various ways, depending on various possible scenarios. In one example, the messaging system 100 may be implemented by way of a spatially collocated arrangement of the server arrangement 102 and the database 110. In another example, the messaging system 100 may be implemented by way of a spatially distributed arrangement of the server arrangement 102 and the database 110 coupled mutually in communication via a communication network, such as the communication network 106. In yet another example, the server arrangement 102 and the database 110 may be implemented via cloud computing services.

The communication network 106 couples the server arrangement 102 to the client devices 104 and the retail stores 108. The communication network 106 provides a communication medium between the server arrangement 102, the client devices 104, and the retail stores 108 for exchanging data amongst themselves.

The communication network 106 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Examples of the client devices 104 include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, large-sized touch screens with embedded PCs, and other interactive devices, such as Television (TV) sets and Set-Top Boxes (STBs).

Examples of the retail stores 108 include, but are not limited to, coffee shops, ice-cream shops, book cafes, restaurants, lunching or dining places, pubs, bars, shops, boutiques, general stores, speciality stores, gift shops, and cinema halls.

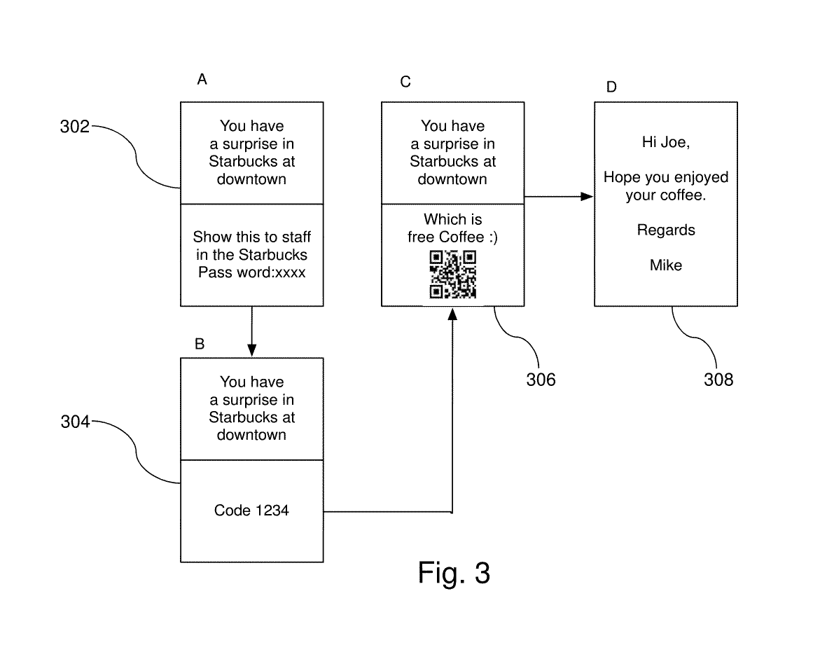

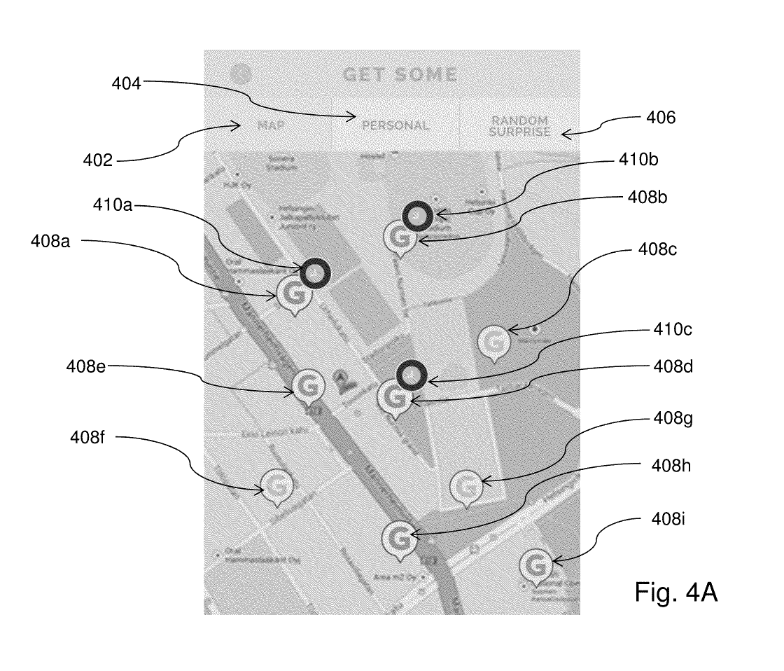

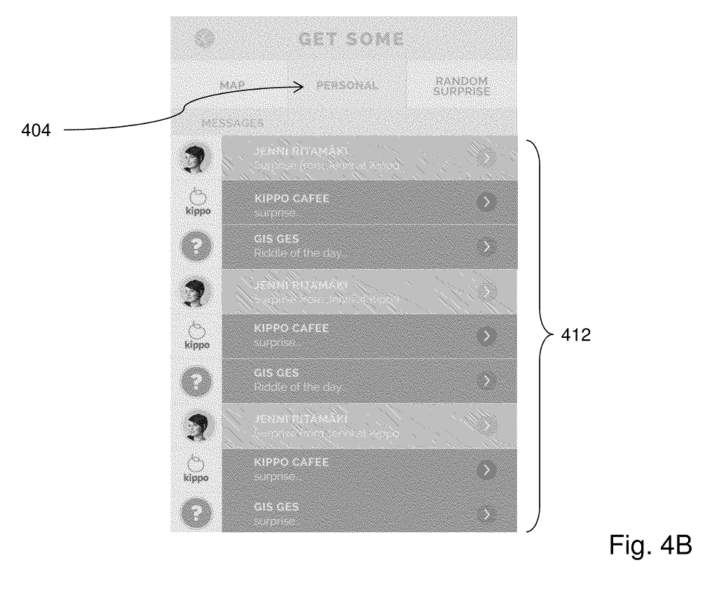

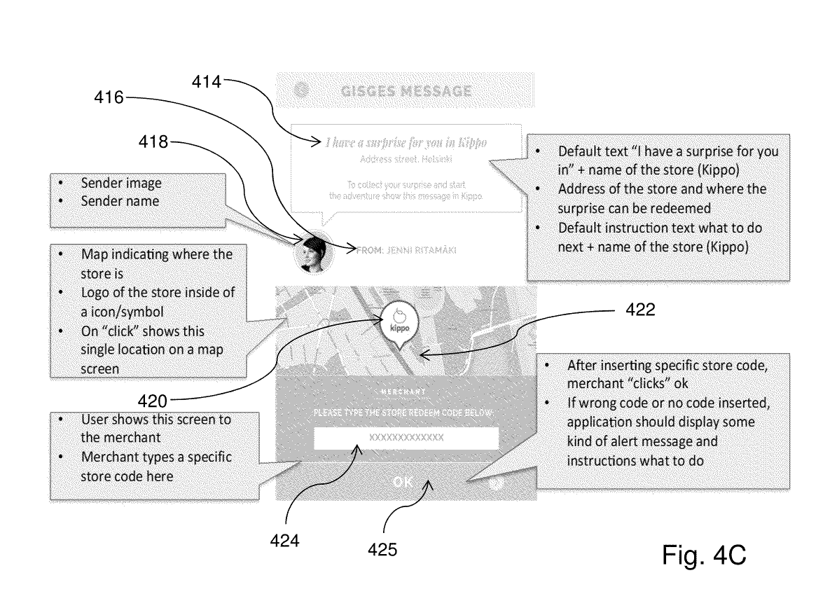

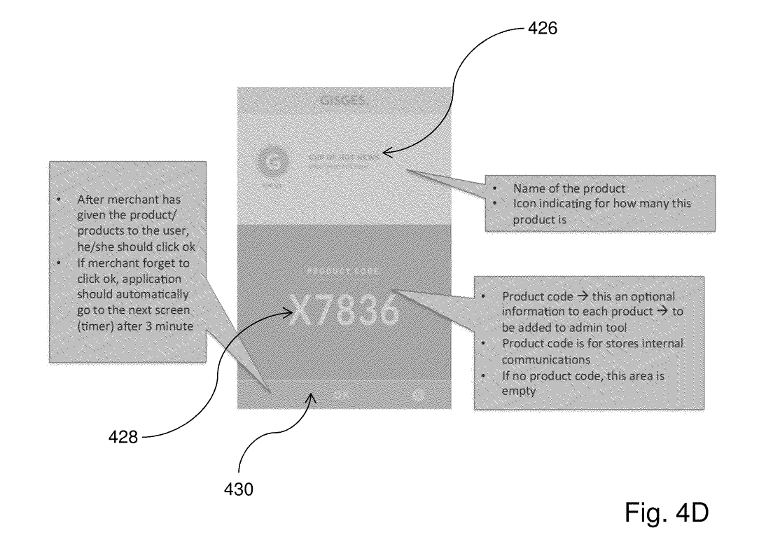

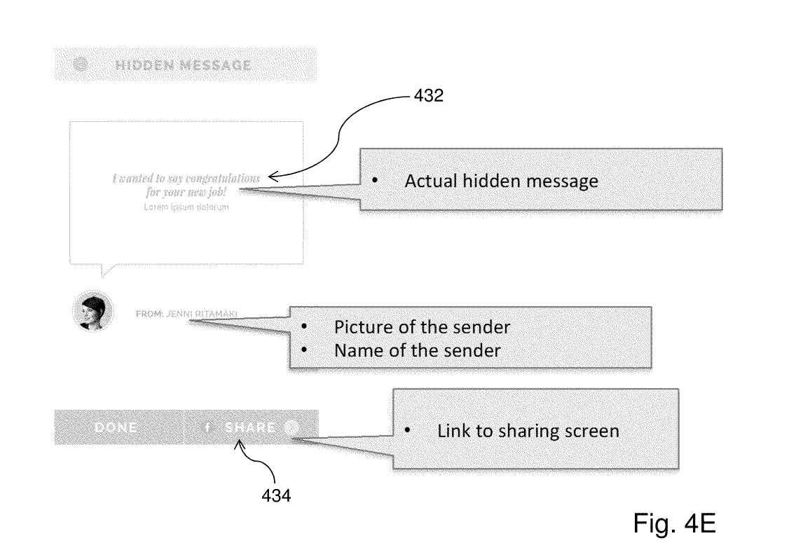

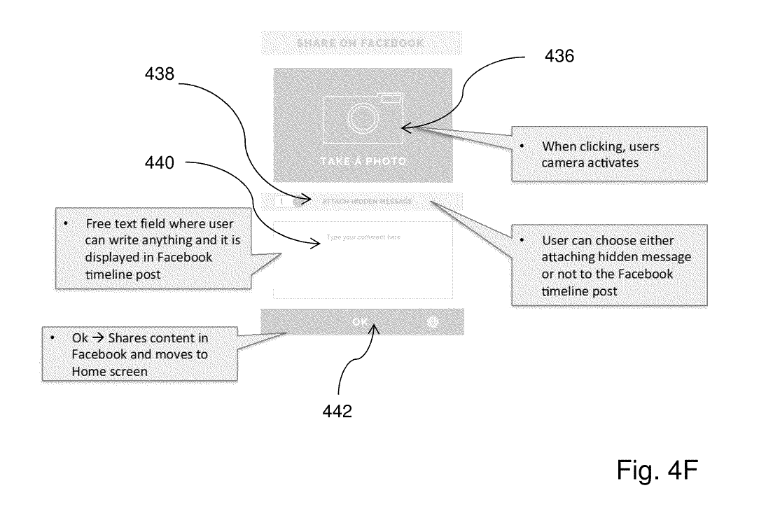

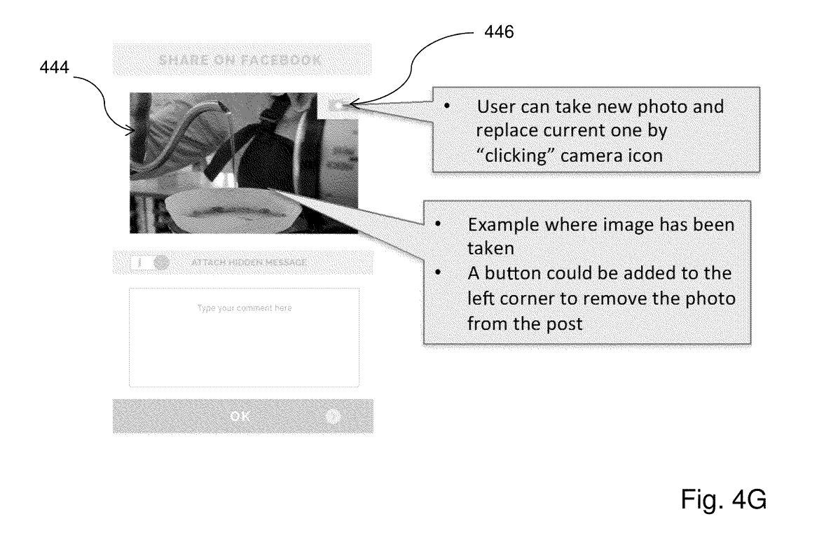

The client devices 104 access various services provided by the server arrangement 102. In order to access the various services provided by the server arrangement 102, each of the client devices 104 optionally employs a software product that provides a user interface to a user associated with that client device. The software product is implemented by way of a native software application, or a software application running on a browser, or a plug-in application provided by a website, such as a social networking website. Details of the user interface have been provided in conjunction with FIGS. 3 and 4A-G.

Moreover, optionally, the server arrangement 102 is operable to perform one or more of:

(i) receive, from a first client device, a message to be delivered to a second client device;
(ii) send, to the second client device, a request message requesting a user associated with the second client device perform a predetermined trigger event;
(iii) deliver at least a portion of the message to the second client device, when the user associated with the second client device performs the predetermined trigger event;
(iv) communicate instructions for providing a reward, for example, redemption of a gift voucher to a corresponding retail store, when the user performs the predetermined trigger event; and/or
(v) deliver a remainder of the message to the second client device, after the reward, in this example, the gift voucher, is redeemed by the user.

FIG. 1 is merely an example, which should not unduly limit the scope of the claims herein. It is to be understood that the specific designation for the messaging system 100 is provided as an example and is not to be construed as limiting the messaging system 100 to specific numbers, types, or arrangements of client devices, retail stores, server arrangements, databases and communication networks. A person skilled in the art will recognize many variations, alternatives, and modifications of embodiments of the present disclosure. While the exemplary embodiments are described as providing gift vouchers, it should be understood that any suitable reward may be provided as part of the disclosed system and method for delivering messages in a gamified manner.

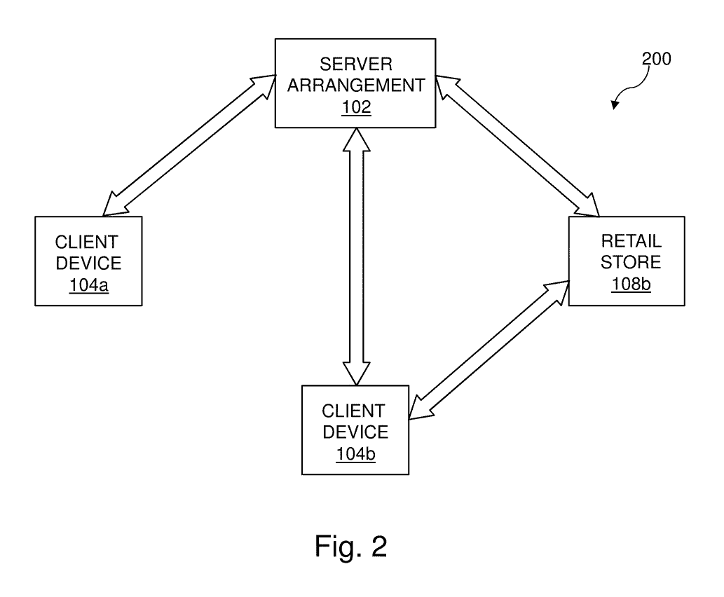

FIG. 2 is a schematic illustration of an example data flow within the messaging system 100, in accordance with an embodiment of the present disclosure. For illustration purposes only, there will now be described an example situation in which a first user associated with a first client device wishes to send a message along with a gift voucher to a second user associated with a second client device, using the messaging system 100. In FIG. 2, the first client device is shown as the client device 104a, while the second client device is shown as the client device 104b.

In order to provide the server arrangement 102 with instructions to deliver the message along with the gift voucher, the first user uses a user interface provided on a display screen of the client device 104a, to perform one or more of:

(i) select the second user from a list of users for sending the message and the gift voucher;
(ii) create the message to be delivered to the client device 104b;
(iii) select, from a list of rewards, in this example, gift vouchers, a reward to be delivered to the client device 104b; and/or
(iv) make a payment for the reward to the server arrangement 102.

Optionally, the list of rewards includes one or more gift vouchers that are available and redeemable at the retail store 108. In the example situation, the gift voucher selected by the first user is redeemable at the retail store 108b.

Optionally, the list of rewards is stored at the database 110 and is accessed by the server arrangement 102 from the database 110.

Upon receiving the instructions from the client device 104a, the server arrangement 102 sends a request message to the client device 104b. The request message includes a request to the second user to perform a predetermined trigger event so as to be able to receive the message and the reward.

Optionally, the predetermined trigger event is considered to be performed when the second user reaches a geographical location where the retail store 108b is located. For this purpose, the client device 104b optionally employs a Global Positioning System (GPS) sensor included therein to send a spatial position of the client device 104b to the server arrangement 102.

Alternatively or additionally, optionally, the predetermined trigger event is considered to be performed when the client device 104b sends a trigger code to the server arrangement 102. For this purpose, the server arrangement 102 delivers, to the retail store 108b, a trigger code to be used for the predetermined trigger event. When the second user reaches the retail store 108b, a merchant or a representative of the retail store 108b provides the trigger code to the second user who then sends the trigger code from the client device 104b to the server arrangement 102.

When the second user performs the predetermined trigger event, the server arrangement 102 delivers at least a portion of the message to the client device 104b. Optionally, the at least a portion of the message includes the reward, for example, the gift voucher.

Additionally, optionally, the server arrangement 102 communicates instructions for redemption of the reward to the retail store 108b when the second user performs the predetermined trigger event.

Moreover, optionally, the server arrangement 102 delivers a remainder of the message to the client device 104b after the reward is redeemed. Optionally, the server arrangement 102 delivers the remainder of the message, when the server arrangement 102 is notified by the retail store 108b that the reward has been redeemed.

Alternatively, optionally, the server arrangement 102 delivers the remainder of the message a predefined time period after the at least a portion of the message is delivered. The predefined time period is either user-defined or system-defined by default. In an example where the predefined time period is five minutes, the remainder of the message is delivered five minutes after the at least a portion of the message is delivered.

Moreover, the server arrangement 102 makes a payment to the retail store 108b for the reward.

FIG. 2 is merely an example, which should not unduly limit the scope of the claims herein. A person skilled in the art will recognize many variations, alternatives, and modifications of embodiments of the present disclosure.

For illustration purposes only, there will next be considered example user interfaces provided on display screens of the client devices 104. FIG. 3 is an illustration of a series of views displayed on an example user interface corresponding to a receiving user, in accordance with an embodiment of the present disclosure.

A first view 302, marked ‘A’ in FIG. 3, is displayed on the example user interface, when a receiving client device receives a request message. In the first view 302, the request message requests the receiving user to perform a predetermined trigger event, namely, to show the request message to a staff in a retail store ‘Starbucks’ and enter a password as a trigger code.

In order to perform the predetermined trigger event, the receiving user then visits the retail store ‘Starbucks’. A second view 304, marked 73′ in FIG. 3, is displayed when the staff in the retail store ‘Starbucks’ enters the trigger code.

Subsequently, a third view 306, marked ‘C’ in FIG. 3, is displayed. The third view 306 presents a gift voucher that is redeemable at the retail store ‘Starbucks’. The third view 306 optionally presents a Quick Response (QR) code, corresponding to the gift voucher, which is then scanned by the staff in the retail store ‘Starbucks’.

Finally, a fourth view 308, marked ‘D’ in FIG. 3, is displayed. The fourth view 308 presents an original message intended for the receiving user. Optionally, the fourth view 308 is displayed after the gift voucher has been redeemed by the receiving user.

FIG. 3 is merely an example, which should not unduly limit the scope of the claims herein. A person skilled in the art will recognize many variations, alternatives, and modifications of embodiments of the present disclosure.

FIGS. 4A-G are illustrations of screenshots of various views displayed on a user interface of a given client device, in accordance with an embodiment of the present disclosure. With reference to FIGS. 4A and 4B, the user interface provides various user-selectable options to a user associated with the given client device, depicted as a map view option 402, a personal message option 404, and a random surprise option 406. With reference to FIG. 4A, a map view is displayed on the user interface. In an example, the map view is displayed on the user interface when the user selects the map view option 402.

In the map view, a plurality of message icons, depicted as message icons 408a, 408b, 408c, 408d, 408e, 408f, 408g, 408h and 408i (hereinafter collectively referred to as message icons 408), are displayed on a map. The message icons 408 are representative of messages that have been received by the user. In an example, the message icons 408 represent personal messages and/or random surprise messages that have been received by the user.

Moreover, the map view displays the message icons 408 at their corresponding locations within the map, for example, including locations the user is supposed to visit to possibly redeem rewards.

Moreover, optionally, timers are displayed adjacent to messages that are time bound. In the map view, timers 410a, 410b and 410c have been displayed adjacent to the message icons 408a, 408b and 408d, thereby indicating that messages associated with the message icons 408a, 408b and 408d are time bound. In an example, a timer is displayed adjacent to a message that is about to expire. In another example, a timer is displayed adjacent to a message that is associated with an instant campaign.

Moreover, the map view allows the user to select a particular message to be opened for purposes of viewing and/or redeeming an associated reward, for example, a gift voucher.

With reference to FIG. 4B, a personal message view is displayed on the user interface. In an example, the personal message view is displayed on the user interface, when the user selects the personal message option 404.

The personal message view displays a list of messages 412. With reference to FIG. 4B, the list of messages 412 includes messages received from friends, retail stores and/or system operators of the messaging system 100.

Moreover, the personal message view allows the user to select, from the list of messages 412, a particular message to be opened for purposes of viewing and/or redeeming an associated gift voucher.

Moreover, the list of messages 412 optionally includes one or more of: read messages, unread messages, messages whose gift vouchers have already been redeemed by the user (hereinafter referred to as “redeemed messages”), and/or messages whose gift vouchers are yet to be redeemed by the user (hereinafter referred to as “unredeemed messages”). Optionally, the redeemed messages are displayed, when an archives option (not shown) is selected by the user.

With reference to FIGS. 4C and 4D, a message view is displayed on the user interface. The message view is displayed when the user selects a particular message to be opened, for example, from the list of messages 412.

With reference to FIG. 4C, a request message corresponding to the particular message is displayed. The request message includes a default text message 414, a profile name 416 of a user who sent the particular message (hereinafter referred to as “sender”), a profile image 418 of the sender, a logo 420 of a retail store, a map 422, and a text box 424.

The default text message 414 optionally includes an address of the retail store where a gift voucher can be redeemed. The default text message 414 optionally includes instructions related to a predetermined trigger event that the user is required to perform.

The logo 420 of the retail store is shown at a corresponding geographical location on the map 422, thereby indicating the geographical location of the retail store. Optionally, the logo 420 is user-selectable. In an example, when the logo 420 is clicked, directions for reaching the retail store are displayed on the map 422.

When the user reaches the retail store, the user shows the request message to a merchant or a sales representative of the retail store. Subsequently, the merchant or the sales representative enters a trigger code in the text box 424, and clicks an ‘OK’ button 425.

Next, in FIG. 4D, a gift voucher view is displayed on the user interface, after the trigger code is verified by the server arrangement 102. The gift voucher view displays a name 426 of a gift that can be redeemed using the gift voucher, a gift code 428 of the gift, and an ‘OK’ button 430. The gift voucher view optionally displays a quantity of the gift that can be redeemed.

Optionally, the gift code 428 is provided for internal and/or commercial communications of the retail store. Optionally, the gift code 428 is used by the retail store for invoicing purposes.

When the gift voucher is redeemed, the merchant or the sales representative of the retail store or the user clicks the ‘OK’ button 430 indicating that the gift voucher has been redeemed. Subsequently, the server arrangement 102 makes a payment to the retail store for the gift voucher. Optionally, the messaging system 100 receives a portion of a transaction profit associated with the gift voucher.

Next, with reference to FIG. 4E, a hidden message view is displayed on the user interface. The hidden message view is displayed after the gift voucher is redeemed or after a predefined time period has passed. The hidden message view displays a remainder 432 of the message sent by the sender.

With reference to FIG. 4E, the hidden message view provides a share button 434 that allows the user to share the message with his/her friends and family, for example, on a social networking website.

With reference to FIG. 4F, a sharing view is displayed on the user interface, when the share button 434 is clicked by the user. The sharing view includes a camera icon 436, an attachment button 438, a free text box 440, and an ‘OK’ button 442.

When selected, the camera icon 436 activates a camera included in the given client device. This allows the user to take a photograph of the gift that he/she received from the sender.

The attachment button 438 allows the user to attach the message received from the sender with the photograph. The free text box 440 allows the user to write a reply message to the sender or an accompanying caption message for the photograph.

When the user clicks the ‘OK’ button 442, inputs provided by the user, namely the photograph taken by the user, the message received from the sender and/or the message written by the user, are shared on the social networking website.

With reference to FIG. 4G, an updated sharing view is displayed on the user interface. The updated sharing view displays a photograph 444 taken by the user, and a camera icon 446 that allows the user to take a new photograph, for example, for replacing the photograph 444.

FIGS. 4A-G are merely examples, which should not unduly limit the scope of the claims herein. A person skilled in the art will recognize many variations, alternatives, and modifications of embodiments of the present disclosure.

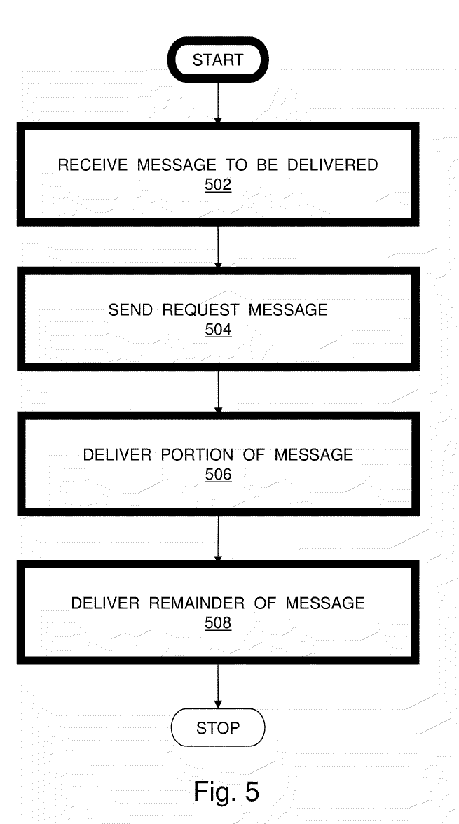

FIG. 5 is an illustration of steps of a method of delivering messages, in accordance with an embodiment of the present disclosure. The method is depicted as a collection of steps in a logical flow diagram, which represents a sequence of steps that can be implemented in hardware, software, or a combination thereof.

For illustration purposes only, the method has been illustrated with reference to the messaging system 100 as described in conjunction with FIG. 1.

At a step 502, the server arrangement 102 receives, from a first client device, a message to be delivered to a second client device.

Next, at a step 504, the server arrangement 102 sends, to the second client device, a request message requesting a user associated with the second client device to perform a predetermined trigger event.

When the user performs the predetermined trigger event, a step 506 is performed. At the step 506, the server arrangement 102 delivers at least a portion of the message to the second client device. As described earlier, the at least a portion of the message includes a gift voucher that is redeemable at a retail store.

Finally, at a step 508, the server arrangement 102 delivers a remainder of the message to the second client device. Optionally, the step 508 is performed after the gift voucher is redeemed.

It should be noted here that the steps 502 to 508 are only illustrative and other alternatives can also be provided where one or more steps are added, one or more steps are removed, or one or more steps are provided in a different sequence without departing from the scope of the claims herein.

Embodiments of the present disclosure provide a computer program product including a non-transitory machine-readable data storage medium having stored thereon program instructions that, when accessed by a processing device, cause the processing device to perform the method as described in conjunction with FIG. 5.

Embodiments of the present disclosure are susceptible to being used for various purposes, including, though not limited to, enabling users to send messages and/or gift vouchers to other users in an interesting and gamified manner.

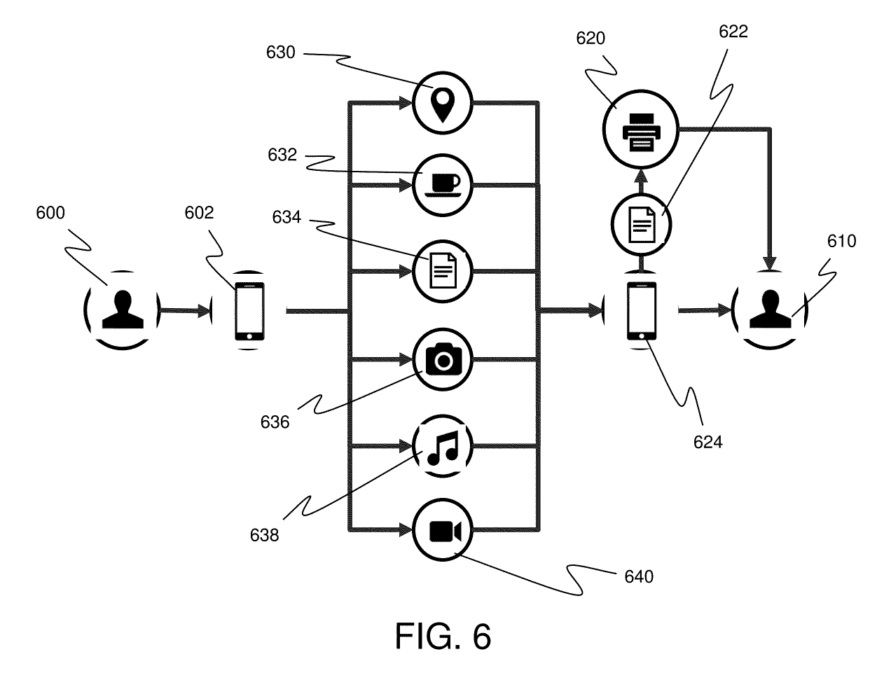

FIG. 6 is an illustration of a process according to embodiments. A first user 600 (sender) has a mobile terminal 602. The first user 600 uses an application in the mobile terminal 602 to select one or more types of messages or parts of the messages to be delivered to a second user 610 (receiver). Example message types can be location related message 630, taste related message 632, textual message 634, image message 636, audio message 638, video message 640 to mention few. For example the first user 600 might select to send a taste related message 632 to the second user 610. First part of the message would indicate to the second user 610 to go to specific place and have for example teaser text such as “sweet moments from me at Café house at Main street 5”. The second user 610 would go to the Café house at indicated location. The application running in the second users mobile phone 624 would be configured to send printing request 622 to a printer 620. Based on embodiments the printer 620 could be wireless printer located at the merchants facility. The printer 620 would print voucher or similar to be used at the Café house. The second user would get the taste message as form of for example piece of cake. Alternatively the voucher could be printed by point of sales terminal.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A messaging system, comprising:
a plurality of clients devices; and
a server arrangement coupled in communication with the plurality of clients devices, wherein the server arrangement is operable to:
receive, from a first client device, a second message to be delivered to a second client device;
send, to the second client device, a first request message requesting a user associated with the second client device to perform a predetermined trigger event; and
deliver at least a portion of the second message to the second client device, when the user associated with the second client device performs the predetermined trigger event.

2. The messaging system as claimed in claim 1, wherein the at least a portion of the second message includes a reward, and wherein the server arrangement is operable to communicate instructions for redemption of the reward to a corresponding enterprise, when the user performs the predetermined trigger event.

3. The messaging system as claimed in claim 2, wherein the predetermined trigger event is performed when the user reaches a geographical location of the enterprise.

4. The messaging system as claimed in claim 2, wherein the server arrangement is operable to deliver, to the enterprise, a trigger code to be used for the predetermined trigger event.

5. The messaging system as claimed in claim 2, wherein the server arrangement is operable to deliver a remainder of the message to the second client device after the reward is redeemed by the user.

6. The messaging system as claimed in claim 2, wherein the enterprise comprises a retail store.

7. The messaging system as claimed in claim 2, wherein the reward comprises a gift voucher.

8. A method of sending messages, comprising:
receiving from a first client device, a second message to be delivered to a second client device;
sending to the second client device, a first message requesting performance of a predetermined trigger event; and
delivering at least a portion of the second message to the second client device upon performance of the predetermined trigger event.

9. The method of claim 8, comprising delivering a reward with the at least a portion of the second message and, upon performance of the predetermined trigger event, communicating instructions for redemption of the reward to an enterprise providing the reward.

10. The method of claim 9, comprising performing the predetermined trigger event upon arriving at the enterprise.

11. The method of claim 9, comprising delivering to the enterprise a trigger code to be used for the predetermined trigger event.

12. The method of claim 9, comprising delivering a remainder of the message to the second client device after the reward is redeemed by the user.

13. The method of claim 9, wherein the enterprise comprises a retail store.

14. The method of claim 9, wherein the reward comprises a gift voucher.

15. A computer program product including a non-transitory machine-readable data storage medium having stored thereon program instructions that, when accessed by a processing device, cause the processing device to perform the method of claim 8.
